(19) United States
(12) Patent Application Publication
(10) Pub. No.: US 2006/0273290 A1
(43) Pub. Date: Dec. 7, 2006

(54) Fire retardant composition

(75) Inventors: Amir G. Khan, Wayne, NJ (US); Burhan Uludag, Budd Lake, NJ (US); Michael D. De Souto, Somerset, MA (US)

Correspondence Address: GAF MATERIALS CORPORATION;Legal Department, Building No. 8, 1361 Alps Road, Wayne, NJ, 07470, US

(73) Assignee: BUILDING MATERIALS INVESTMENT CORPORATION

(21) Appl. No.: 11/141,829

(22) Filed: Jun. 1, 2005

(51) Int. Cl. C09K 21/00

(52) U.S. Cl. 252/606

(57) ABSTRACT

The present invention is directed to a fire retardant composition, comprising: a primer solution; expandable graphite particles; triethyl phosphate; and aluminum trihydrate, wherein the triethyl phosphate comprises from about 1 wt. % to about 15 wt. % based on the weight of the composition.

### FIELD OF THE INVENTION

In general, the present invention is directed to a fire retardant composition. More particularly, the present invention is directed to a fire retardant composition that may be applied to a variety of substrates to protect the substrate from excessive heat and/or fire.

### BACKGROUND OF THE INVENTION

Fire causes billions of dollars in damage, and extensive loss of life each year. Exposed flammable surfaces, including but not limited to building surfaces such as roof decks, siding, and the like, may inadvertently lead to the spread of fires. It is often desirable to protect these surfaces from exposure to high temperatures and/or fire.

Various embodiments of the present invention may be suitable for use in connection with building materials, and other applications. Various embodiments may provide a composition that may protect a substrate from exposure to high temperatures and/or fire. In addition, the process of making a composition in accordance with some embodiments of the present invention may provide a composition with improved fire retardant performance. Additional advantages of embodiments of the invention are set forth, in part, in the description which follows and, in part, will be apparent to one of ordinary skill in the art from the description and/or from the practice of the invention.

### SUMMARY OF INVENTION

Responsive to the foregoing challenges, Applicant has developed an innovative fire retardant composition. The composition may comprise: a primer solution; expandable graphite particles; triethyl phosphate; and aluminum trihydrate. In one embodiment, the triethyl phosphate comprises from about 1 wt. % to about 15 wt. % based on the weight of the composition. In one embodiment, the expandable graphite particles comprise from about 2 wt. % to about 60 wt. % based on the weight of the composition. In one embodiment, the aluminum trihydrate comprises from about 5 wt. % to about 45 wt. % based on the weight of the composition. In one embodiment, the primer solution comprises about 62 wt. % based on the weight of the composition. In one embodiment the primer solution comprises styrene butadiene and water. In another embodiment, the primer solution comprises asphalt and a solvent.

Applicant also has developed an innovative fire retardant composition comprising: asphalt; a solvent, wherein the asphalt and the solvent are combined to form a primer solution; expandable graphite particles; triethyl phosphate; and aluminum trihydrate, wherein the triethyl phosphate comprises from about 1 wt. % to about 15 wt. % based on the weight of the composition. In one embodiment, the triethyl phosphate comprises from about 2 wt. % to about 7 wt. % based on the weight of the composition. In another embodiment, the triethyl phosphate comprises about 3 wt. % based on the weight of the composition.

It is to be understood that the both the foregoing general description and the following detailed description are exemplary and explanatory only, and are not restrictive of the invention as claimed.

### DETAILED DESCRIPTION OF EMBODIMENTS OF THE INVENTION

Reference will now be made in detail to embodiments of the present invention. As embodied herein, embodiments of the present invention include a composition comprising a fire retardant primer and process of making the same that may be applied to a variety of substrates to protect the substrate from excessive heat and/or fire.

The composition of the present invention may include a primer solution. In one embodiment, the primer solution may comprise a binder, and water. In one embodiment, the binder may comprise styrene butadiene (SBR). As will be apparent to one of ordinary skill in the art, SBR may be commercially available. The primer solution comprising SBR may include, but is not limited to, NS-104, NS-222, styranol ND656, styranol ND4680, acranol s-728, and/or styrofan nx6650x, which are examples of SBR supplied by BASF. Other commercial or non-commercially available SBR are considered well within the scope and spirit of the present invention. In other embodiments, the primer solution may include binders, including, but not limited to, acrylics, latex acrylics, styrene acrylics, vinyl, elastomers, and the like.

In one embodiment, the primer solution comprises from about 5 wt. % to about 75 wt. % SBR and from about 5 wt. % to about 60 wt. % water based on the weight of the composition. In another embodiment, the primer solution more particularly comprises about 46.2 wt. % SBR and about 25.0 wt. % water based on the weight of the composition.

In an alternative embodiment, the primer solution may comprise asphalt and a solvent. In one embodiment, the- primer solution may comprise about 70 wt. % asphalt and about 30 wt. % solvent. The asphalt may comprise Grade 20, Grade 10, Grade 5, flux, coating, or any other suitable asphalt material. In one embodiment the solvent may comprise mineral spirits. Other solvents, including, but not limited to, kwik dri66, hi-sol 100, cypar 9, and/or other solvents adapted to keep the primer in solution are considered to be well within the scope and spirit of the present invention.

In one embodiment of the present invention the primer solution comprises from about 50 wt. % to about 75 wt. % based on the weight of the composition. In another embodiment, the primer solution more particularly comprises about 62 wt. % based on the weight of the composition.

The addition of the primer solution to the composition may make the composition of the present invention applicable to various substrates. By varying the amount of water or solvent used, the composition may be more or less viscous, as desired.

The composition of the present invention may include expandable graphite particles. Expandable graphite is known to have intumescing properties that may decrease thermal conductivity and provide flame retardation to the substrate. Expandable graphite particles are known to rapidly expand in volume when exposed to temperatures exceeding a certain “onset” temperature. The expandable graphite of the present invention may comprise any suitable particle size and “onset” temperature. As will be apparent to one of ordinary skill in the art, the expandable graphite may be commercially available. The expandable graphite particles may include, but are not limited to, 160-50, 220-50, 160-80, and 220-80 which are examples of expandable graphite particles supplied by Graftech. Other commercial or non-commercially available expandable graphite particles are considered well within the scope and spirit of the present invention. In one embodiment, the graphite particles may be chemically treated. The graphite particles may be acidic-treated, basic-treated, and/or neutral-treated.

In one embodiment of the present invention, the expandable graphite particles comprise from about 2 wt. % to about 60 wt. % based on the weight of the composition. In another embodiment, the expandable graphite particles may more particularly comprise from about 12 wt. % to about 20 wt. % based on the weight of the composition. In another embodiment, the expandable graphite particles may more particularly comprise about 17.1 wt. % based on the weight of the composition.

The composition of the present invention may include triethyl phosphate (TEP). Triethyl phosphate is known to have fire retardant properties. As will be apparent to one of ordinary skill in the art, the triethyl phosphate may be commercially available. Commercial examples of triethyl phosphate may be supplied, for example, by Aldrich, Fischer, and Chemcentral. Other commercial or non-commercially available triethyl phosphate is considered well within the scope and spirit of the present invention.

In one embodiment of the present invention, the triethyl phosphate comprises from about 1 wt. % to about 15 wt. % based on the weight of the composition. In another embodiment, the triethyl phosphate may more particularly comprise from about 2 wt. % to about 7 wt. % based on the weight of the composition. In another embodiment, the triethyl phosphate may more particularly comprise about 3 wt. % based on the weight of the composition.

The composition of the present invention may include aluminum trihydrate (ATH). The aluminum trihydrate may be adapted to promote absorbency in the composition. When exposed to high temperatures the aluminum trihydrate may release water molecules. These released water molecules combine with carbon dioxide (a natural byproduct of the combustion, and readily found in the ambient environment during a high temperature/flame event) and may form a flame resistant gas layer on the substrate. In addition to the expandable graphite and the triethyl phosphate, this may provide further flame resistance. As will be apparent to one of ordinary skill in the art, the aluminum trihydrate may be commercially available, supplied by, for example, Franklin, Tenn. Lutrell, Blue Mountain Minerals, Huber and Aluchem. Other commercial or non-commercially available aluminum trihydrate is considered well within the scope and spirit of the present invention.

In one embodiment of the present invention, the aluminum trihydrate comprises from about 5 wt. % to about 45 wt. % based on the weight of the composition. In another embodiment, the aluminum trihydrate may more particularly comprise from about 10 wt. % to about 30 wt. % based on the weight of the composition. In another embodiment, the aluminum trihydrate may more particularly comprise about 22.9 wt. % based on the weight of the composition.

In one embodiment of the present invention, the composition may further include a surfactant, or wetting agent, to promote the mixing of the various components of the composition. The surfactant may comprise, for example, a stearate. The amount of surfactant in the composition may vary and may be adjusted based on need. In one embodiment, the surfactant comprises from about 0.1 wt. % to about 0.6 wt. % based on the weight of the composition. In another embodiment, the surfactant may more particularly comprise about 0.5 wt. % based on the weight of the composition. The surfactant may additionally maintain the pH level of the composition at a desired level.

In one embodiment, the composition may further comprise a thickening agent to promote the mixing of the various components of the composition. The thickening agent may comprise an organic thickener and/or an inorganic thickener. The thickening agent may include, but is not limited to, alcogum VEP-1 or any other suitable commercial or non-commercially available thickening agent. In one embodiment, the thickening agent may comprise about 0.1 wt. % based on the weight of the composition.

In one embodiment, the composition may further comprise a carrier, such as, for example, glycol. The glycol may mix with water in the composition and prevent dryout and hardening of the composition. In one embodiment, the glycol may comprise about 2.5 wt. % based on the weight of the composition. The composition may further comprise oil, or similar lubricant. The oil may promote a homogeneous phase in the composition, and may promote adhesion of the composition to the substrate. In one embodiment, the oil may comprise about 2 wt. % based on the weight of the composition.

The process of making the composition in accordance with one embodiment of the present invention will now be described. Water is first mixed with triethyl phosphate. As stated above, in one embodiment, about 3 wt. % triethyl phosphate and about 25 wt. % water based on the weight of the composition may be provided. About 2.5 wt. % glycol and about 0.5 wt. % surfactant based on the weight of the composition may also be added to the mixture. SBR is then added to the mixture, and the entire mixture is stirred. As stated above, in one embodiment, about 46.2 wt. % SBR based on the weight of the composition may be provided. The aluminum trihydrate and expandable graphite are then added to the mixture. As stated above, in one embodiment, about 22.9 wt. % aluminum trihydrate and about 17.1 wt. % expandable graphite based on the weight of the composition may be provided. About 2.0 wt. % oil and about 0.1 wt. % thickening agent based on the weight of the composition may also be added to the mixture. All of the components may be blended in appropriate containers in a manner known in the art.

The resulting component may be applied to a substrate to provide improved fire retardant capability. For example, the composition of the present invention may be applied to a substrate including, but not limited to, plywood deck, base sheets, insulation facers, membranes, fiberboard, perlite, gypsum, densdeck, insulation, a modified bitumen system, a built-up roof (BUR) system (including mineral surface, granule embedded, and/or gravel surfaced cap sheet; ply sheet; and/or base sheet), glass shingles, organic based shingles, metal shingles, concrete, steel, and/or any combination thereof. The composition of the present invention may be applied to the substrate using known techniques including, but not limited to, brushing, roller coating, foam spray, water spray, and/or other suitable application techniques. The composition may be applied to the substrate in the field, or in a factory environment.

By way of example, and not limitation, Table I below sets forth a formulation of the fire retardant composition of the present invention according to one embodiment.

### EXAMPLE

TABLE I

| Compound | Formula |
|---|---|
| H₂O | 25.0% |
| TEP | 3.0% |
| Glycol | 2.5% |
| A. Stearate | 0.5% |
| SBR | 46.2% |
| ATH | 22.9% |
| Expandable Graphite | 17.1% |
| Oil | 2.0% |
| Thickner | 0.1% |

Samples of the formulation shown in Table I were subjected to Burning Brand Tests, Intermittent Flame Tests, and Spread of Flame Tests according to ANSI/UL 790 (Eighth Edition), which is a standard used to evaluate roof covering materials and roof systems for resistance to external fire exposure. A copy of ANSI/UL 790 (Eighth Edition) is incorporated herein by reference in its entirety. The results of the testing are summarized in Tables II-IV below.

### Burning Brand Test

Four separate burning brand tests were conducted on a system comprising a sample of the formulation shown in Table I at 1 gal/sq (total 888 grams per deck) and a membrane comprising EverGuard TPO, 45 mil, mechanically fastened. For each test, a test deck was constructed in accordance with Paragraph 4.2 of ANSI/UL 790. The roof covering material was applied in accordance with Paragraph 4.4 of ANSI/UL 790. The test sample was conditioned in accordance with Paragraph 4.5 of ANSI/UL 790. The results of the tests are summarized in Table II below.

TABLE II
Burning Brand Test No. 1

| | |
|---|---|
| Specifications | |
| Brand Weight (g): | 1895 |
| Deck Thickness (in): | 15/32 |
| Ambient Temp (° F.): | 75 |
| Slope (in/ft): | ½ |
| Underside Activity | |
| First Smoke (Hr:Min:Sec): | 00:11:17 |
| First Asphalt Drip (Hr:Min:Sec): | NA |
| First Glow (Hr:Min:Sec): | NA |
| Flames On Underside (Hr:Min:Sec): | None |
| Char Depth (inches): | ¼ |
| Test Duration (Hr:Min:Sec): | 00:50:44 |
| Test Observations | |
| 00:01:41 Surface flames 1 foot above top of brand | |
| 00:02:59 Surface flames 2 feet above top of brand | |
| 00:03:55 Surface flames 2-½ feet above top of brand | |
| 00:07:15 Brand 25% consumed | |
| 00:11:17 Smoke on underside at Horizontal Joint | |
| 00:11:20 Surface flames ½ foot above top of brand | |
| 00:21:05 Brand 100% consumed | |
| 00:50:34 All action ceased and the test was terminated | |
| 00:50:44 All action ceased, test terminated | |

Burning Brand Test No. 2

| | |
|---|---|
| Specifications | |
| Brand Weight (g): | 1894 |
| Deck Thickness (in): | 15/32 |
| Ambient Temp (° F.): | 75 |
| Slope (in/ft): | ½ |
| Underside Activity | |
| First Smoke (Hr:Min:Sec): | 00:10:46 |
| First Asphalt Drip (Hr:Min:Sec): | NA |
| First Glow (Hr:Min:Sec): | 00:22:21 |
| Flames On Underside (Hr:Min:Sec): | None |
| Char Depth (inches): | ½ |
| Test Duration (Hr:Min:Sec): | 01:30:14 |
| Test Observations | |
| 00:01:46 Surface flames above top of brand | |
| 00:02:02 Surface flames 1 foot above top of brand | |
| 00:02:43 Surface flames 1-½ feet above top of brand | |
| 00:03:47 Surface flames 2 feet above top of brand | |
| 00:04:57 Brand 25% consumed | |
| 00:09:07 Brand 50% consumed | |
| 00:10:46 Smoke on underside of Horizontal Joint | |
| 00:13:34 Discoloration on underside at plywood joint | |
| 00:14:19 Brand 75% consumed | |
| 00:17:07 Smoke continues on underside | |
| 00:22:21 Glow on underside at Horizontal Joint | |
| 00:26:30 Brand 100% consumed | |
| 00:30:35 Smoke continues on underside | |
| 00:33:52 Glow continues on underside | |
| 00:48:45 Glow continues on underside | |
| 01:03:51 Glow continues on underside | |
| 01:30:04 Test terminated per UL790 Paragraph 8.5.1 | |
| 01:30:14 Test terminated | |

Burning Brand Test No. 3

| | |
|---|---|
| Specifications | |
| Brand Weight (g): | 1957 |
| Deck Thickness (in): | 15/32 |
| Ambient Temp (° F.): | 74 |
| Slope (in/ft): | ½ |
| Underside Activity | |
| First Smoke (Hr:Min:Sec): | 00:06:15 |
| First Asphalt Drip (Hr:Min:Sec): | NA |
| First Glow (Hr:Min:Sec): | 00:18:52 |
| Flames On Underside (Hr:Min:Sec): | None |
| Char Depth (inches): | ½ |
| Test Duration (Hr:Min:Sec): | 01:30:17 |
| Test Observations | |
| 00:02:05 Surface flames above top of brand | |
| 00:02:05 Surface flames ½ foot above top of brand | |
| 00:02:11 Surface flames 1 foot above top of brand | |
| 00:02:56 Surface flames 1-½ feet above top of brand | |
| 00:03:54 Surface flames 2 feet above top of brand | |
| 00:06:15 Smoke on underside at Horizontal Joint | |
| 00:07:31 Brand 25% consumed | |
| 00:10:54 Brand 50% consumed | |
| 00:12:21 Discoloration on underside at plywood joint | |
| 00:15:55 Discoloration of plywood on underside | |
| 00:17:22 Smoke continues on underside | |
| 00:17:33 Brand 75% consumed | |
| 00:18:52 Glow on underside at Horizontal Joint | |
| 00:23:55 Brand 100% consumed | |
| 00:25:42 Glow continues on underside | |
| 00:29:23 Smoke continues on underside | |
| 00:36:58 Glow continues on underside | |
| 00:44:29 Smoke continues on underside | |
| 00:56:40 Glow continues on underside | |
| 01:12:38 Glow continues on underside | |
| 01:30:05 Test terminated per UL790 Paragraph 8.5.1 | |
| 01:30:17 Test terminated | |

Burning Brand Test No. 4

| | |
|---|---|
| Specifications | |
| Brand Weight (g): | 0 |
| Deck Thickness (in): | 15/32 |
| Ambient Temp (° F.): | 74 |
| Slope (in/ft): | ½ |
| Underside Activity | |
| First Smoke (Hr:Min:Sec): | 00:11:17 |
| First Asphalt Drip (Hr:Min:Sec): | NA |
| First Glow (Hr:Min:Sec): | NA |
| Flames On Underside (Hr:Min:Sec): | None |
| Char Depth (inches): | ¼ |
| Test Duration (Hr:Min:Sec): | 00:55:48 |
| Test Observations | |
| 00:01:06 Surface flames ½ foot above top of brand | |
| 00:01:07 Surface flames 1 foot above top of brand | |
| 00:02:08 Surface flames 1-½ feet above top of brand | |
| 00:04:07 Surface flames 2 feet above top of brand | |
| 00:05:48 Brand 25% consumed | |
| 00:09:33 Brand 50% consumed | |
| 00:11:17 Smoke on underside at Horizontal Joint | |
| 00:15:09 Discoloration on underside at plywood joint | |
| 00:16:08 Brand 75% consumed | |
| 00:20:44 Smoke continues on underside | |
| 00:25:27 Brand 100% consumed | |
| 00:30:49 Smoke continues on underside | |
| 00:40:03 Smoke continues on underside | |
| 00:55:34 All action ceased and the test was terminated | |
| 00:55:48 All action ceased, test terminated | |

In each of the burning brand test nos. 1-4 summarized in Table II, no portion of the roof covering material was blown or fell off the test deck in the form of flaming/glowing brands. The roof deck was not exposed by breaking, sliding, cracking, or warping of the roof covering. No portions of the roof deck fell away in the form of glowing particles. There was no sustained flaming on the underside of the deck.

### Intermittent Flame Test

Two separate intermittent flame tests were conducted on a system comprising a sample of the formulation shown in Table I at 1 gal/sq (total 888 grams per deck). For each test, a test deck was constructed in accordance with Paragraph 4.2 of ANSI/UL 790. The roof covering material was applied in accordance with Paragraph 4.4 of ANSI/UL 790. The test sample was conditioned in accordance with Paragraph 4.5 of ANSI/UL 790. The results of the tests are summarized in Table III below.

TABLE III
Intermittent Flame Test No. 1

| | |
|---|---|
| Specifications | |
| Deck Thickness (in): | 15/32 |
| Ambient Temp (° F.): | 74 |
| Slope (in/ft): | 1 |
| Char Depth (inches): | ¼ |
| Test Duration (Hr:Min:Sec): | 01:51:56 |
| Underside Activity | |
| First Smoke (Hr:Min:Sec): | 00:22:26 |
| First Asphalt Drip (Hr:Min:Sec): | NA |
| First Glow (Hr:Min:Sec): | 00:59:24 |
| Flames On Underside(Hr:Min:Sec): | NA |

Surface Flames

| | Test Time | Ignition | Flames Out | Max. Flame Travel |
|---|---|---|---|---|
| Cycle | (Min) | (Min:Sec) | (Min:Sec) | (ft) |
| 1 | 0-4 | 00:41 | Still Flaming | 1.5 |
| 2 | 4-8 | N/A | None | |
| 3 | 8-12 | N/A | None | |
| 4 | 12-16 | N/A | None | |
| 5 | 16-20 | N/A | None | |
| 6 | 20-24 | N/A | None | |
| 7 | 24-28 | N/A | None | |
| 8 | 28-32 | N/A | None | |
| 9 | 32-36 | N/A | None | |
| 10 | 36-40 | N/A | None | |
| 11 | 40-44 | N/A | None | |
| 12 | 44-48 | N/A | None | |
| 13 | 48-52 | N/A | None | |
| 14 | 52-56 | N/A | None | |
| 15 | 56-60 | None | N/A | None |

Intermittent Flame Test No. 2

| | |
|---|---|
| Specifications | |
| Deck Thickness (in): | 15/32 |
| Ambient Temp (° F.): | 73 |
| Slope (in/ft): | 1 |
| Char Depth (inches): | ⅛ |
| Test Duration (Hr:Min:Sec): | 01:19:18 |
| Underside Activity | |
| First Smoke (Hr:Min:Sec): | 00:58:16 |
| First Asphalt Drip (Hr:Min:Sec): | NA |
| First Glow (Hr:Min:Sec): | NA |
| Flames On Underside (Hr:Min:Sec): | NA |

Surface Flames

| | Test Time | Ignition | Flames Out | Max. Flame Travel |
|---|---|---|---|---|
| Cycle | (Min) | (Min:Sec) | (Min:Sec) | (ft) |
| 1 | 0-4 | 00:38 | 00:34 | 1 |
| 2 | 4-8 | N/A | None | |
| 3 | 8-12 | N/A | None | |
| 4 | 12-16 | N/A | None | |
| 5 | 16-20 | N/A | None | |
| 6 | 20-24 | N/A | None | |
| 7 | 24-28 | N/A | None | |
| 8 | 28-32 | N/A | None | |
| 9 | 32-36 | N/A | None | |
| 10 | 36-40 | N/A | None | |
| 11 | 40-44 | N/A | None | |
| 12 | 44-48 | N/A | None | |
| 13 | 48-52 | N/A | None | |
| 14 | 52-56 | N/A | None | |
| 15 | 56-60 | None | N/A | None |

In each of the intermittent flame test nos. 1-2 summarized in Table III, no portion of the roof covering material was blown or fell off the test deck in the form of flaming/glowing brands. The roof deck was not exposed by breaking, sliding, cracking, or warping of the roof covering. No portions of the roof deck fell away in the form of glowing particles. There was no sustained flaming on the underside of the deck

### Spread of Flame Test

Six separate burning brand tests were conducted on a system comprising a sample of the formulation shown in Table I at 1 gal/sq (total 2131 grams per deck). In test nos. 1 and 2, the system further comprised a membrane comprising EverGuard TPO, 45 mil, mechanically fastened. In test nos. 3 and 4, the system further comprised a membrane comprising EverGuard TPO, 45 mil, self-adhered. In test nos. 5 and 6, the system further comprised a base sheet comprising one ply Type G2, mechanically fastened, and a membrane comprising Ruberoid Torch Granule, heat fused. For each test, a test deck was constructed in accordance with Paragraph 4.3 of ANSI/UL 790. The roof covering material was applied in accordance with Paragraph 4.4 of ANSI/UL 790. The test sample was conditioned in accordance with Paragraph 4.5 of ANSI/UL 790. Flame spread data was determined based upon ANSI/UL 790. The results of the tests are summarized in Table IV below.

TABLE IV
Spread of Flame Test No. 1

| | |
|---|---|
| Specifications | |
| Ambient Temp (° F.): | 74 |
| Slope (in/ft): | ½ |
| Test duration: | 10 minutes |

Flame Spread Data

| Distance (feet) | Time (Min:Sec) |
|---|---|
| Ignition | 00:32 |
| 0.5 | 00:32 |
| 1 | 00:56 |
| 1.5 | 01:18 |
| 2 | 03:57 |
| 2.5 | 07:47 |

The maximum spread of flame of the roof covering material was 2.50 feet.

Spread of Flame Test No. 2

| | |
|---|---|
| Specifications | |
| Ambient Temp (° F.): | 70 |
| Slope (in/ft): | 1 |
| Test duration: | 10 minutes |

Flame Spread Data

| Distance (feet) | Time (Min:Sec) |
|---|---|
| Ignition | 00:29 |
| 0.5 | 00:29 |
| 1 | 00:33 |
| 1.5 | 00:54 |
| 2 | 02:54 |
| 2.5 | 04:45 |
| 3 | 08:18 |

The maximum spread of flame of the roof covering material was 3.00 feet.

Spread of Flame Test No. 3

| | |
|---|---|
| Specifications | |
| Ambient Temp (° F.): | 70 |
| Slope (in/ft): | 1 |
| Test duration: | 10 minutes |

Flame Spread Data

| Distance (feet) | Time (Min:Sec) |
|---|---|
| Ignition | 00:34 |
| 0 | 00:34 |
| 0.5 | 00:37 |
| 1 | 00:42 |
| 1.5 | 00:56 |
| 2 | 01:46 |
| 2.5 | 03:14 |
| 3 | 06:21 |

The maximum spread of flame of the roof covering material was 3.00 feet.

Spread of Flame Test No. 4

| | |
|---|---|
| Specifications | |
| Ambient Temp (° F.): | 72 |
| Slope (in/ft): | 1 |
| Test duration: | 10 minutes |

Flame Spread Data

| Distance (feet) | Time (Min:Sec) |
|---|---|
| Ignition | 00:30 |
| 0.5 | 00:30 |
| 1 | 00:44 |
| 1.5 | 01:05 |
| 2 | 01:32 |
| 2.5 | 02:58 |
| 3 | 04:49 |
| 3.5 | 07:36 |

The maximum spread of flame of the roof covering material was 3.50 feet.

Spread of Flame Test No. 5

| | |
|---|---|
| Specifications | |
| Ambient Temp (° F.): | 75 |
| Slope (in/ft): | ½ |
| Test duration: | 10 minutes |

Flame Spread Data

| Distance (feet) | Time (Min:Sec) |
|---|---|
| Ignition | 00:49 |
| 0 | 00:49 |
| 0.5 | 00:50 |
| 1 | 00:59 |
| 1.5 | 01:05 |
| 2 | 01:20 |
| 2.5 | 01:59 |
| 3 | 02:46 |
| 3.5 | 03:13 |
| 1.5 | 07:25 |

The maximum spread of flame of the roof covering material was 3.50 feet.

Spread of Flame Test No. 6

| | |
|---|---|
| Specifications | |
| Ambient Temp (° F.): | 76 |
| Slope (in/ft): | 1 |
| Test duration: | 10 minutes |

Flame Spread Data

| Distance (feet) | Time (Min:Sec) |
|---|---|
| Ignition | 00:43 |
| 0.5 | 00:43 |
| 1 | 00:47 |
| 1.5 | 00:49 |
| 2 | 00:56 |
| 2.5 | 01:07 |
| 3 | 01:49 |
| 3.5 | 02:02 |
| 4 | 02:53 |
| 4.5 | 03:39 |
| 0 | 07:35 |
| 1.5 | 07:36 |

The maximum spread of flame of the roof covering material was 4.50 feet.

In each of the spread of flame test nos. 1-6 summarized in Table IV, there was no significant lateral spread of flame from the path directly exposed to the test flame. No portion of the roof covering material was blown or fell off the test deck in the form of flaming/glowing brands. The roof deck was not exposed by breaking, sliding, cracking, or warping of the roof covering. No portions of the roof deck fell away in the form of glowing particles.

It will be apparent to those skilled in the art that variations and modifications of the present invention can be made without departing from the scope or spirit of the invention. It is intended that the present invention cover all such modifications and variations of the invention, provided they come within the scope of the appended claims and their equivalents.

What is claimed is:

1. A fire retardant composition, comprising:
a primer solution;
expandable graphite particles;
triethyl phosphate; and
aluminum trihydrate.

2. The composition of claim 1, wherein the triethyl phosphate comprises from about 1 wt. % to about 15 wt. % based on the weight of the composition.

3. The composition of claim 1, wherein the triethyl phosphate comprises from about 2 wt. % to about 7 wt. % based on the weight of the composition.

4. The composition of claim 1, wherein the triethyl phosphate comprises about 3 wt. % based on the weight of the composition.

5. The composition of claim 1, wherein the expandable graphite particles comprise from about 2 wt. % to about 60 wt. % based on the weight of the composition.

6. The composition of claim 1, wherein the expandable graphite particles comprise from about 12 wt. % to about 20 wt. % based on the weight of the composition.

7. The composition of claim 1, wherein the expandable graphite particles comprise about 17.1 wt. % based on the weight of the composition.

8. The composition of claim 1, wherein the aluminum trihydrate comprises from about 5 wt. % to about 45 wt. % based on the weight of the composition.

9. The composition of claim 1, wherein the aluminum trihydrate comprises from about 10 wt. % to about 30 wt. % based on the weight of the composition.

10. The composition of claim 1, wherein the aluminum trihydrate comprises about 22.9 wt. % based on the weight of the composition.

11. The composition of claim 1, wherein the primer solution comprises a binder and water.

12. The composition of claim 1, wherein the primer solution comprises styrene butadiene and water

13. The composition of claim 1, wherein the primer solution comprises asphalt and a solvent.

14. The composition of claim 1, wherein the primer solution comprises about 62 wt. % based on the weight of the composition.

15. The composition of claim 12, wherein the primer solution comprises about 46.2 wt. % styrene butadiene based on the weight of the composition.

16. The composition of claim 13, wherein the primer solution comprises about 70 wt. % asphalt and about 30 wt. % solvent.

17. A fire retardant composition, comprising:
a primer solution;
expandable graphite particles;
triethyl phosphate; and
aluminum trihydrate,
wherein the triethyl phosphate comprises from about 1 wt. % to about 15 wt. % based on the weight of the composition.

18. The composition of claim 17, wherein the triethyl phosphate comprises about 3 wt. % based on the weight of the composition.

19. The composition of claim 17, wherein the primer solution comprises styrene butadiene and water.

20. The composition of claim 17, wherein the primer solution
comprises asphalt;
a solvent, wherein the asphalt and the solvent are combined to form a primer solution.
